(19) United States
(12) Patent Application Publication
(10) Pub. No.: US 2012/0025532 A1
(43) Pub. Date: Feb. 2, 2012

(54) WAVE POWER GENERATOR

(76) Inventor: KI-SUK SONG, GONGJU (KR)

(21) Appl. No.: 12/911,073

(22) Filed: Oct. 25, 2010

(30) Foreign Application Priority Data
Jul. 30, 2010 (KR) 1020100073859

(51) Int. Cl. F03B 13/12

(52) U.S. Cl. 290/53

(57) ABSTRACT

A wave power generator includes a frame unit mounted on the shore, an electric generator unit generating electricity by means of a rotating motion of a rotor, a drive unit having a plurality of wave-power receiving bodies receiving the energy of a reciprocating horizontal motion of wave power and reciprocating between the sea-side and the land-side, wherein the wave-power receiving bodies are mounted in the frame unit in a stepwise manner in a plan view so that the wave-power receiving bodies do not meet the waves at the same time, and a power transmission unit mounted in the frame unit to convert a linear motion of the drive unit into a rotating motion and transmit the rotating motion to the rotor of the generator unit.

### BACKGROUND OF THE INVENTION

1. Field of the Invention

The present invention relates, in general, to a wave power generator and, more particularly, to a wave power generator that sequentially and efficiently converts swelling wave power (a force applied parallel to the horizon by swelling waves) into electric energy in conformity with wave periods, thereby generating electricity in a cheap, environment-friendly manner.

2. Description of the Related Art

Generally, electricity generation is carried out using different power sources including waterpower based on the water level, steam power using heat from the combustion of fuel, nuclear power, or the like.

Recently, power generation technology using alternative natural power including wind power, solar power, tidal power, or the like, instead of steam power, nuclear power, waterpower or the like, has been becoming more popular, and is receiving attention as a next generation growth industry for environment-friendly, green energy.

Further, tidal power generation using tidewater is a power generation technology that is amenable to regions contiguous to a sea or an island, so that it is possible to perform continuous power generation, and the construction cost is relatively lower than that of wind power generation, solar power generation or the like.

Most conventional technologies used in tidal power generation are conducted so that vertical wave motion is converted into a rotating motion and then power generation is performed. Such power generation that uses the energy of vertical wave motion requires that a power station be mounted in a floating state on the sea, so that it is very difficult to construct a buoyant body and the power structure.

Korean patent No. 10-0886837 disclosed a new conceptual power generation method in which power generation is performed using horizontal motion energy of wave power which is generated when waves come in and go out repeatedly between sea-side and land-side.

### SUMMARY OF THE INVENTION

Accordingly, the present invention has been made keeping in mind the above problems occurring in the related art of Korean patent No. 10-0886837, and the present invention is directed to a wave power generator capable of continuously generating electricity using wave power, irrespective of the periods of waves.

In order to achieve the above object, according to one aspect of the present invention, there is provided a wave power generator including: a frame unit mounted on the shore; an electric generator unit generating electricity by means of a rotating motion of a rotor; a drive unit having a plurality of wave-power receiving bodies receiving the energy of a reciprocating horizontal motion of wave power and reciprocating between the sea-side and the land-side, wherein the wave-power receiving bodies are mounted in the frame unit in a stepwise manner in a plan view so that the wave-power receiving bodies do not meet the waves at the same time; and a power transmission unit mounted in the frame unit to convert a linear motion of the drive unit into a rotating motion and transmit the rotating motion to the rotor of the generator unit.

In an exemplary embodiment, the drive unit may include the wave-power receiving bodies having a shape of a barrel so that they effectively receive wave power and which are mounted immersed below the surface of the sea, a connecting rod connecting the wave-power receiving body on one end and the power transmission unit on the other end, and a plurality of link members mounted between the frame unit and the wave-power receiving bodies so that upon receiving the wave power, the link members swing about the frame unit while supporting the wave-power receiving bodies.

In an exemplary embodiment, the wave-power receiving bodies may be arranged stepwise such that if a plurality of imaginary lines is drawn parallel to the swells of waves, at least one wave-power receiving body does not lie on the same imaginary line.

In an exemplary embodiment, the stepwise distance between the wave-power receiving bodies may preferably be different, which allows the bodies to effectively cope with varying periods of the swells.

In an exemplary embodiment, the link member may have 2˜5 joints.

In an exemplary embodiment, the power transmission unit may convert a reciprocating motion of the drive unit into one-way rotating motion and transmit the rotating motion to the rotor of the generator, using a one-way clutch or pressurized fluid.

According to the wave power generator of the embodiments, the wave-power receiving bodies are arranged stepwise and separated by different stepwise distances, so that even in a resting period of the respective swells in which a direction of wave action reverses when waves repeatedly go in and out, the drive unit is able to continuously receive wave power which is generated by other swells, thereby continuously generating electricity.

Furthermore, the wave-power receiving bodies are supported by the link members such that the link members can swing, so that when receiving wave power, the bodies can be effectively supported in conformity with the height and width of irregular swells.

### BRIEF DESCRIPTION OF THE DRAWINGS

The above and other objects, features and advantages of the present invention will be more clearly understood from the following detailed description when taken in conjunction with the accompanying drawings, in which:

FIG. 1 is a block diagram illustrating a wave power generator according to an embodiment of the invention;

FIG. 2 is a perspective view illustrating a wave power generator according to an embodiment of the invention;

FIG. 3 is a partially enlarged view illustrating the state of a wave-power receiving body of the wave power generator which has been installed;

FIG. 4 is a partially enlarged cross-sectional view illustrating the shape of the wave-power receiving body;

FIG. 5 is a partially enlarged side view illustrating the state of the wave power generator in which wheels are mounted to a frame unit, and a wire is bound to the wave-power receiving body;

FIG. 6 is a perspective view illustrating another example of a wave-power receiving body;

FIG. 7 is a partially enlarged side view illustrating the cooperative operation of the wave-power receiving body and the link members;

FIG. 8 is a conceptual plan view illustrating major parts of a wave power generator of an embodiment; and

FIG. 9 is a hydraulic and pneumatic circuit diagram illustrating a hydraulic and pneumatic system which is adapted to a power transmission unit of the wave power generator.

### DETAILED DESCRIPTION OF THE INVENTION

Reference will now be made in greater detail to a preferred embodiment of the invention, an example of which is illustrated in the accompanying drawings. Wherever possible, the same reference numerals will be used throughout the drawings and the description to refer to the same or like parts.

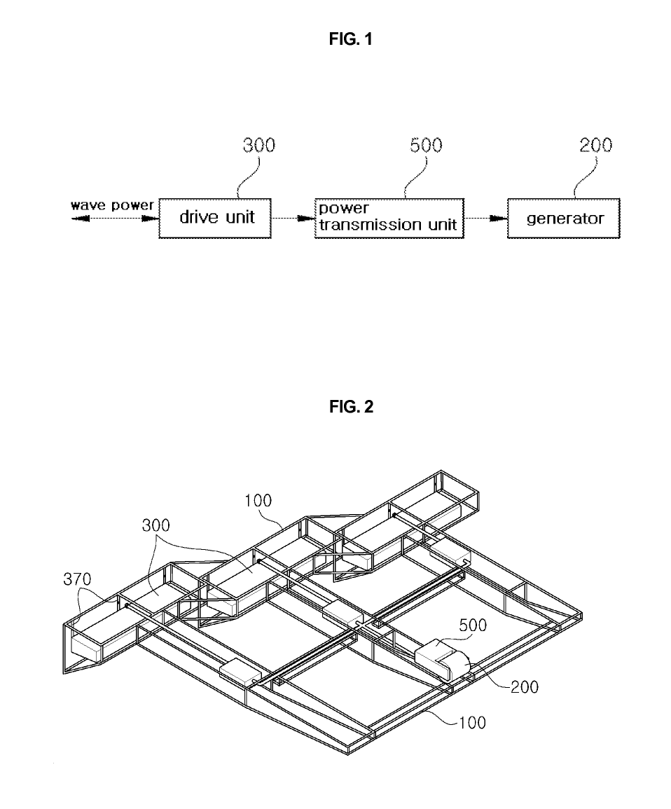

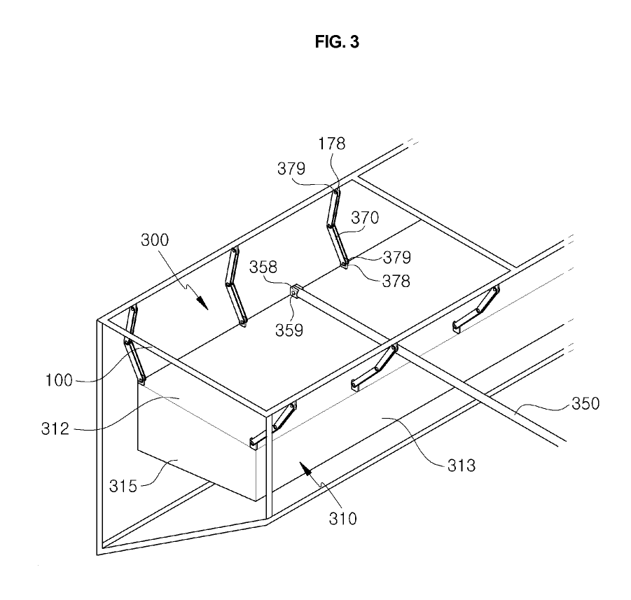

A wave power generator of an embodiment, as shown in FIGS. 1 and 2, includes a frame unit 100, a power generator unit (or an electric generator unit) 200, a drive unit, and a power transmission unit 500.

The frame unit 100 is made of steel and installed on the seashore.

The frame unit 100 is firmly installed on the shore such that it is kept fixed even when subjected to swelling waves.

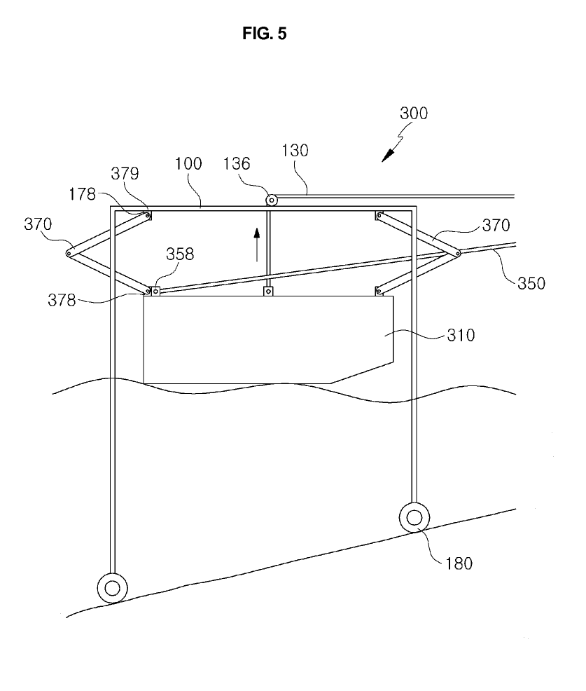

As shown in FIG. 5, the frame unit 100 may be provided with wheels 180 in order to move the frame unit in preparation for a storm or a tidal wave so that the frame unit should be unfixed and transported to a safe place on land.

Then, the seashore or the land where the frame unit is installed may be provided on the bottom with a rail (not shown) for guiding the wheels to move the frame unit.

Here, the frame unit 100 may be partially disassembled and moved, or otherwise may be transported in one piece.

The power generator 200 is an apparatus for generating electricity using a rotating motion of a rotor. Since the generator may adopt a variety of known constructions to convert mechanical kinetic energy into electric energy, the detailed explanation thereof will be omitted.

The drive unit 300 serves to receive the reciprocating horizontal kinetic energy of wave power and reciprocate between the sea-side and the land-side (i.e. a forward and backward motion or a swing motion relative to the fixed frame unit).

The drive unit 300, as shown in FIGS. 2 to 4, includes a wave-power receiving body 310 mounted immersed below the surface of the sea and receiving the wave power, and a connecting rod 350 connected between the wave-power receiving body 310 on one side and a power transmission unit 500 on the other side.

The frame unit 100 may be provided with a guide rail (not shown) to minimize the shaking of the connecting rod 350 when moving in a forward direction (towards the sea) and a backward direction (towards the land). The guide rail may be configured into a form such as a tube, a tunnel, or a recess, through which the connecting rod 350 passes. For example, it may be configured such that a wheel is mounted onto the connecting rod 350 so that the wheel moves, slides or rolls on the guide rail.

The connecting rod 350 may be of a shape of a rod, and may be configured as structures like a trapezoid, a truss or the like that can sufficiently endure the load of wave power.

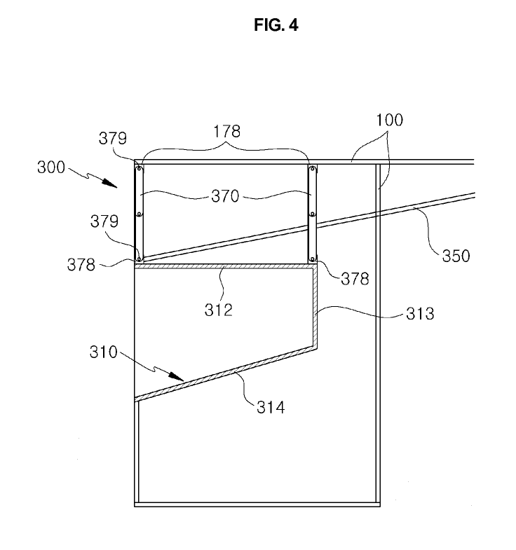

The wave-power receiving body 310 is a box-type body. An end of the body 310 opens towards the side of the sea, as shown in FIG. 4.

The box-type body which is concave in a direction from the sea-side to the land-side can effectively receive wave power because waves flood into the concave portion of the body. For example, the wave-power receiving body 310 may be of a section such as “U” type, “V”type, “ [symbol] ”type, “C” type, or the like.

The wave-power receiving body 310, as shown in FIG. 4, is configured so that an upper plate 312 is disposed parallel to the horizon, and a lower plate 314 is integrally connected to the upper plate 312 at a certain angle (e.g. 10° to 80°).

Here, the upper plate 312 and the lower plate 314 may be directly connected to each other, or otherwise may be connected via a separate back plate 313.

Disposing the lower plate 314 at an angle to the horizon brings about the advantageous effect whereby sand, mud, foreign matter, shellfish or the like, which has gone into the wave-power receiving body 310, together with seawater, naturally flows out and gets removed from the body when the seawater flows out.

The wave-power receiving body 310 also has a pair of side plates 315 on the left side and right side of the upper plate 312 and the lower plate 314, thereby forming the box-type body.

The wave-power receiving body 310, as shown in FIGS. 3 and 4, can move forward and backward or swing relative to the frame unit 100 because of the plurality of link members 370.

The link members 370 are connected between the frame unit 100 and the wave-power receiving body 310 in such a manner that one end is rotatably connected to a fixing bracket 178 of the frame unit 100 by means of a hinge pin 379, and the other end is rotatably connected to a support bracket 378 mounted on the upper plate 312 of the wave-power receiving body 310 by means of a hinge pin 379.

The arrangement of the link members 370 allows the wave-power receiving body 310 to conduct a swinging motion (or a forward and backward reciprocating motion) around the frame unit 100 when wave power is exerted to the wave-power receiving body 310.

Although FIGS. 3 and 4 depict the link member 370 consisting of two joints, the link member may consist of a single joint or three or more joints. It is more advantageous for the link member 370 to consist of two to five joints in view of strength, manufacturing, expectations about the degree of freedom of motion, or the like of the link member.

As not shown in the figures, the wave-power receiving body 310 may be provided on the circumference with a buoyant body such as porous foam-like synthetic resin, an air bag, an air box structure, or the like.

Further, it is possible to detachably connect an air hose (not shown) to the upper plate of the wave-power receiving body in order to inject and draw air into and from the body.

If the wave-power receiving body 310 is large enough to sufficiently stand up to the wave power, the body may weigh up to a few tons or tens of tons, so that it is difficult to control the immersed level of the body 310 using the buoyant body.

Thus, the embodiment in which the wave-power receiving body 310 is mounted to and supported by the frame unit 100 using the link member 370 is very effective when mounting the wave-power receiving body 310.

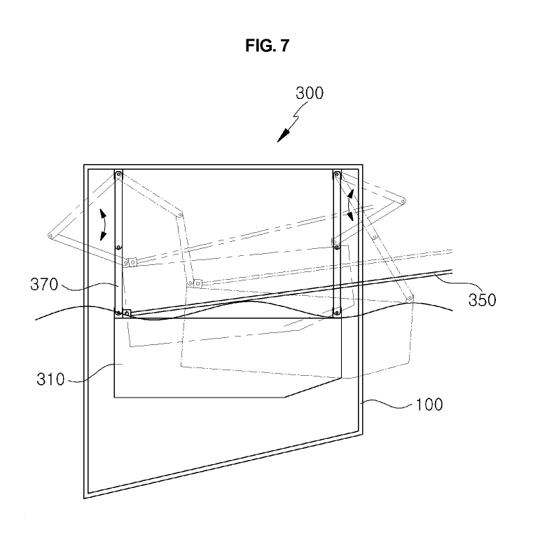

If the wave-power receiving body 310 is supported using the articulated link member 370 as such, as shown in FIG. 7, the wave-power receiving body 310 is able to move in a vertical direction as well as in a horizontal direction (forward and backward direction) in response to the swells of waves while the link member 370 changes its state (e.g. solid line→double-dotted line→single-dotted line→solid line).

Thus, even when the wave power is exerted to the wave-power receiving body 310, the wave power is not completely transferred to the frame unit 100, preventing the structure from being damaged.

Further, the link member 370 serves to restrict lateral motion (a lateral direction perpendicular to a propagation direction of waves) of the wave-power receiving body 310, thereby enabling waves to be only applied to the body 310 in a forward and backward direction.

The respective joint of the link member 370 may be composed of a single member, or of multiple members having excellent strength, which may be configured into a trapezoidal or truss structure.

Further, as shown in FIG. 5, if the swell of the waves is very large, the structures including the wave-power receiving body 310 are likely to be damaged or break; in order for waves not to be directly applied to the body 310, a wire 130 that is connected to a winch (not shown) may be connected to the wave-power receiving body 310 to lift the body 310 to a level above the surface of the sea.

The frame unit 100 may be provided with a guide roller 136 for guiding the wire 130.

The arrangement of the wire 130 connected to the wave-power receiving body 310 to control the level of the body enables power generation output to be controlled in response of the magnitude of waves.

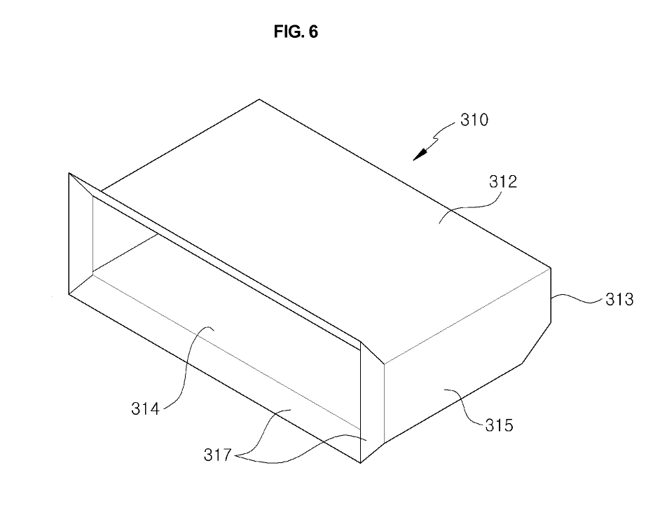

The wave-power receiving body 310 may be provided on the front side (towards the sea-side) with an inclined guide plate 317 which is inclined inwards to effectively guide inflow waves into the inside space, as shown in FIG. 6.

The guide plate 317 may flare out of an inlet of the wave-power receiving body 310 so that a great quantity of inflowing waves can be more rapidly guided into the inside space.

The guide plate 317 may be preferably formed along the entire circumference of the inlet of the wave-power receiving body 310 to effectively guide the waves.

The arrangement of the guide plate 317 serves to effectively collect wave power, thereby increasing energy efficiency.

The wave-power receiving bodies 310, as shown in FIG. 2, are mounted in the frame unit 100 in a stepwise manner as viewed in a plan view so that the wave-power receiving bodies 310 do not encounter waves at the same time.

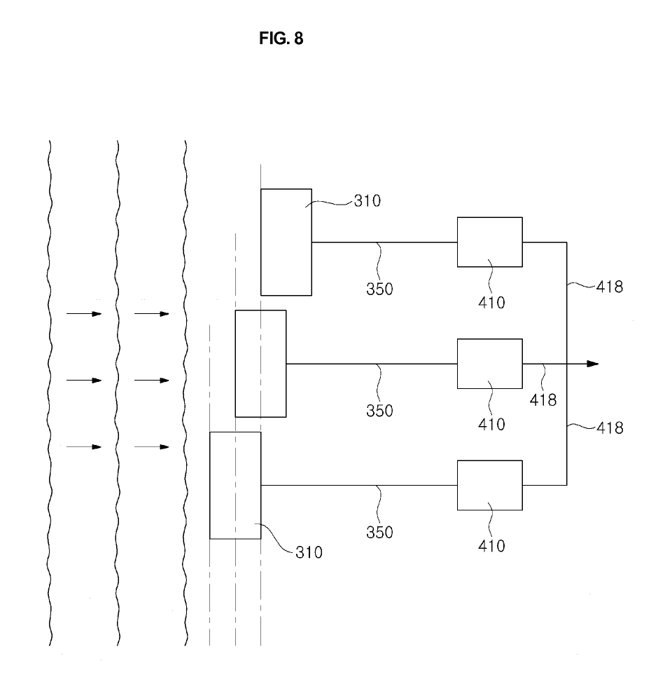

That is, for example, the wave-power receiving bodies may be arranged stepwise such that if a plurality of imaginary lines (double-dotted line) is drawn parallel to swells of waves as shown in FIG. 8, at least one wave-power receiving body 310 does not lie on one imaginary line.

For example, waves flood in a cycle of 7 to 14 seconds when waves are weak and 4 to 6 seconds when waves are strong, so that there is a resting period during which the swells stop and a direction of waving action becomes reversed when waves repeatedly go in and out. Thus, if all of the wave-power receiving bodies 310 are arranged so as to simultaneously come into contact with the same swell of waves, the wave-power receiving bodies 310 cannot continuously receive the wave power.

Thus, if the wave-power receiving bodies 310 are arranged stepwise so that they sequentially meet the waves that have a diversity of periods, for example one body 310 receives wave power and then another body 310 receives wave power with a time difference between them (which is different from the period of wave), the wave-power receiving bodies 310 can continuously receive wave power without there being a resting time.

The wave-power receiving bodies 310 may be configured so that the stepwise distance between the wave-power receiving bodies is different, which preferably allows the bodies to effectively cope with varying periods of the swells. For example, the distance between the first and second bodies and the distance between the second and third bodies are made different.

The connecting rod 350 is rotatably connected on one end to the wave-power receiving body 310 as shown in FIG. 3.

For example, a boss member 358 is installed on the upper plate 312 of the wave-power receiving body 310. One end of the connecting rod 350 is rotatably connected to the boss member 358 by means of a hinge pin 359. Such a connection prevents an overload from being applied to the connecting rod 350 even when wave power is exerted in all directions.

According to the construction of the drive unit 300, when waves go in and out in a horizontal direction between the sea-side and the land-side, the reciprocating horizontal force of wave power is applied to the wave-power receiving bodies. Thus, the wave-power receiving bodies 310 repeatedly reciprocate between the sea-side and the land-side, and the connecting rod 350, which is connected to the body 310, also repeatedly reciprocates in a forward direction (towards the sea-side) and a backward direction (towards the land-side) relative to the frame unit 100.

The power transmission unit 500, as shown in FIG. 1, serves to convert a linear motion of the drive unit 300 into a rotating motion and transmit the rotating motion to the rotor of the generator 200.

The power transmission unit may be mounted on the frame unit 100, or otherwise on the land-side on the shore.

The power transmission unit 500 converts a reciprocating motion of the drive unit 300 into one-way rotating motion and transmits the rotating motion to the rotor of the generator 200, using a one-way clutch or pressurized fluid.

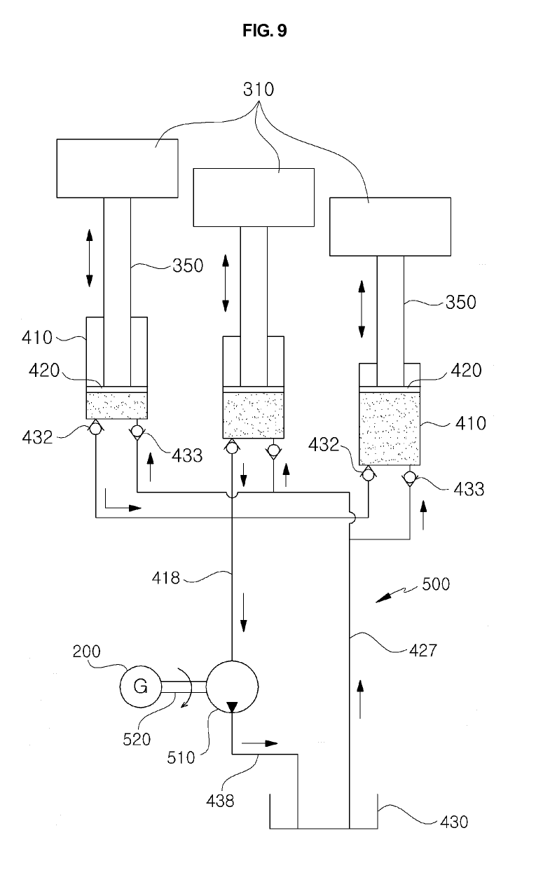

For example, the power transmission unit 500, as shown in FIGS. 8 and 9, may employ a hydraulic and pneumatic system using pressurized fluid.

The power transmission unit 500, as shown in FIGS. 8 and 9, includes a cylinder 410 which is operatively connected to the connecting rod 350 of the drive unit 300.

A piston 420 is provided in the cylinder 410 and is connected to the connecting rod 350.

The connection between the piston 420 and the connection rod 350 is made by means of a universal joint, a flexible coupling, a hinge, or the like such that the connection is capable of moving in vertical and horizontal directions. This is advantageous because even if the reciprocating motion of the connection rod 350 is slightly shunted due to irregular motion of waves, a motion of the piston 420 is continuously conducted in a constant, stable manner in the cylinder 410.

A pressure feed pipe 418, through which internal pressurized fluid is discharged, and a fluid supply pipe 427, which is connected to a pressurized fluid supply source 430 and supplies the pressurized fluid into the cylinder 410, are connected to the cylinder 410.

The pressurized fluid supply source 430 may be composed of a storage tank storing pressurized fluid therein. The pressurized fluid stored in the supply source 430 is forced to move towards the cylinder 410 via the fluid supply pipe 427 by means of vacuum pressure caused by a backward motion of the cylinder 410 (a motion of the wave-power receiving body 310 moving towards the sea-side).

If there is an insufficient supply of pressurized fluid supplied from the pressurized fluid supply source 430 by means of vacuum pressure, a pump (not shown) may be further installed.

Although the pressurized fluid supplied from the source 430 may use gas and oil (unpressurized liquid), hydraulic oil used in a hydraulic system is preferably used because it works well under high pressure and the pressure is able to be precisely controlled. The cylinder 410 may be a pneumatic cylinder if gas is used as the pressurized fluid, or a hydraulic cylinder if hydraulic oil is used as the pressurized fluid.

To the cylinder 410, first and second check valves 432 and 433 are mounted on locations where the pressure feed pipe 418 and the fluid supply pipe 427 are connected.

The first check valve 432 serves to discharge the pressurized fluid towards the pressure feed pipe 418 when the cylinder 410 conducts a forward motion (a motion of the wave-power receiving body 310 towards the land-side by means of wave power), but block inflow of the pressurized fluid from the pressure feed pipe 418 into the cylinder 410.

The second check valve 433 serves to allow the pressurized fluid to flow from the fluid supply pipe 427 towards the cylinder 410 when the cylinder 410 conducts a backward motion, but blocks the discharge of the pressurized fluid from the cylinder 410 towards the fluid supply pipe 427.

The power transmission unit 500, as shown in FIG. 9, further includes a pump 510 connected to the pressure feed pipe 418 so as to generate a rotating force by means of the pressurized fluid sprayed from the pressure feed pipe 418, and a transmitter 520 which transmits the rotating force of the pump 510 to the rotor of the generator 200.

The pump 510 may be any of a variety of different kinds of pumps (the term, ‘pump’ used herein, includes a structure such as a turbine structure because the turbine structure can perform the same function as the pump). For example, the pump 510 may include centrifugal pumps, mixed flow pumps, axial flow pumps, rotary pumps, or the like.

The pump 510 may be used as a motor by reversing the normal function of a pump which is to forcedly supply the pressurized fluid. For example, while the normal function of a pump is conducted so that pressurized fluid sucked through an inlet is forcedly supplied to an outlet by rotating a shaft by means of a rotating force of a motor or the like, the pump 510 is configured so that as the pressurized fluid comes in, the shaft rotates and outputs a rotating force. The technology whereby the pump 510 functions as a motor is well known in the art, so the detailed description will be omitted.

The pump 510 generates a rotating force in such a manner that the pressurized fluid, supplied via the pressure feed pipe 418, impacts an impeller so that the axis of the impeller rotates to generate the rotating force.

It is possible to connect a drain pipe 438 to the outlet of the pump 510 in order to collect the pressurized fluid, which was used for generating the rotating force, in the pressurized fluid supply source 430.

Next, a power generation procedure using the wave power generator of the invention will be described.

First, when the wave power of waves that come in towards the land is exerted onto the wave-power receiving bodies 310 of the drive unit 300, the wave-power receiving bodies 310 move towards the land, the connecting rod 350 connected to the bodies 310 moves backwards (a motion towards the land from the sea), and the piston 420 of the power transmission unit 500, which is connected to the connecting rod 350, moves in the direction that compresses the pressurized fluid in the cylinder 410.

When fluid pressure in the cylinder 410 is increased by the action of the piston 420, the first check valve opens, but the second check valve closes, so that the pressure feed pipe 418 feeds the pressurized fluid from the cylinder 410 towards the pump.

The pressurized fluid passing through the pressure feed pipe 418 causes a rotating force to occur while it passes through the pump 510, and the rotating force rotates the rotor of the generator 200 via the transmitter 520, thereby generating electricity.

Even when waves come in and go out, so that a resting period is generated, the wave-power receiving bodies 310, which are arranged stepwise, sequentially receive different wave power from different waves, thereby implementing continuous power generation.

On the contrary, when the wave power of waves that go out towards a sea is exerted to the wave-power receiving bodies 310 and the wave-power receiving bodies 310 move towards the side of the sea, the piston 420 moves in the direction from the land towards the sea so that the cylinder 410 is in a vacuum, the first check valve 432 closes and the second check valve 433 opens, and the pressurized fluid is fed from the fluid source 430 into the cylinder 410 via the fluid supply pipe 427.

The above procedure repeats so that one-way flowing is continuously exerted to the pump 510 through the pressure feed pipe 418, so that the pump 510 is operated to rotate in a continuous, identical direction, thereby implementing continuous power generation.

While the embodiment has described the power transmission unit 500 as employing a hydraulic and pneumatic system such as e.g. a cylinder, the present invention is not limited thereto; i.e., the power transmission unit may adopt a variety of apparatuses so long as they can convert a forward and backward reciprocating motion of the wave-power receiving body 310 into a rotating motion and transmit the converted motion to the rotor of the generator 200. For example, the power transmission unit 500 may adopt a motion-turning section and a one-way rotary section which are disclosed in Korean patent no. 10-0886837.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A wave power generator comprising:
a frame unit mounted on the shore;
an electric generator unit generating electricity by means of a rotating motion of a rotor;
a drive unit having a plurality of wave-power receiving bodies receiving the energy of a reciprocating horizontal motion of wave power and reciprocating between the sea-side and the land-side, wherein the wave-power receiving bodies are mounted in the frame unit in a stepwise manner in a plan view so that the wave-power receiving bodies do not meet the waves at the same time; and
a power transmission unit mounted in the frame unit to convert a linear motion of the drive unit into a rotating motion and transmit the rotating motion to the rotor of the generator unit.

2. The wave power generator according to claim 1, wherein the wave-power receiving bodies is arranged stepwise such that if a plurality of imaginary lines is drawn parallel to the swells of waves, at least one wave-power receiving body does not lie on the same imaginary line.

3. The wave power generator according to claim 2, wherein the stepwise distance between the wave-power receiving bodies is different.

4. The wave power generator according to claim 2, wherein the drive unit includes the wave-power receiving bodies having a shape of a barrel so that they effectively receive wave power and which are mounted immersed below the surface of the sea, a connecting rod connecting the wave-power receiving body on one end and the power transmission unit on the other end, and a plurality of link members mounted between the frame unit and the wave-power receiving bodies so that upon receiving the wave power, the link members swing about the frame unit while supporting the wave-power receiving bodies.

5. The wave power generator according to claim 4, wherein the link member has 2˜5 joints.

6. The wave power generator according to claim 4, wherein the power transmission unit converts a reciprocating motion of the drive unit into one-way rotating motion and transmits the rotating motion to the rotor of the generator unit, using a one-way clutch or pressurized fluid.

7. The wave power generator according to claim 6, wherein the power transmission unit includes: a cylinder having a piston operatively connected to the connecting rod of the drive unit; a pressure feed pipe connected to the cylinder and through which pressurized fluid is discharged; a fluid supply pipe connected to a pressurized fluid supply source and the cylinder to supply pressurized fluid into the cylinder; a first check valve mounted on a region where the pressure feed pipe of the cylinder is connected and which is operated so that when the cylinder moves forward, the first check valve allows the pressurized fluid to be discharged towards the pressure feed pipe, but blocks the pressurized fluid from being supplied into the cylinder from the pressure feed pipe; a second check valve mounted on a region where the fluid supply pipe of the cylinder is connected and which is operated so that when the cylinder moves backward, the second check valve allows the pressurized fluid to be supplied towards the cylinder from the fluid supply pipe, but blocks the pressurized fluid from being discharged towards the fluid supply pipe from the cylinder; a pump connected to the pressure feed pipe, the pump generating a rotating force by means of the pressurized fluid sprayed from the pressure feed pipe; and a transmitter transmitting the rotating force of the pump to the rotor of the generator unit.
